(19) United States
(12) Patent Application Publication
(10) Pub. No.: US 2025/0389441 A1
(43) Pub. Date: Dec. 25, 2025

(54) Modular Plug-and-Play BMS Control Box for Simplified Integration and Control of Multiple Standalone HVAC Systems

(71) Applicant: Raymond Brokofsky, Trenton, NJ (US)

(72) Inventor: Raymond Brokofsky, Trenton, NJ (US)

(21) Appl. No.: 18/750,230

(22) Filed: Jun. 21, 2024

(51) Int. Cl. F24F 11/56; H01R 13/642; H02G 3/08; H02G 3/14; H02G 3/18

(52) U.S. Cl. CPC F24F 11/56; H01R 13/642; H02G 3/081; H02G 3/088; H02G 3/14; H02G 3/18

(57) ABSTRACT

A modular, plug-and-play Building Management System (BMS) control box for streamlining the integration and control of multiple standalone HVAC systems in large commercial and industrial facilities. The control box comprises a pre-wired enclosure with a generic BACnet MSTP thermostat and a wireless device securely mounted inside, exposing only specific plugs for technicians to connect, ensuring each input and output can only be matched to its corresponding plug, thereby preventing incorrect installations. The invention reduces installation costs, enhances reliability, and offers flexibility and scalability by simplifying the integration process, minimizing wiring requirements, and enabling easy expansion to accommodate additional HVAC units as needed. The modular design allows for customization to suit specific facility requirements and environments.

### BACKGROUND

### Field of the Invention

The present invention relates generally to the field of building management systems and more specifically to a modular, plug-and-play control box for integrating and controlling heating, ventilation, and air conditioning (HVAC) systems in commercial and industrial facilities.

### Description of the Related Art

In large commercial and industrial facilities, managing and controlling multiple standalone HVAC systems can be a complex and costly endeavor. Traditionally, integrating these systems requires extensive wiring and custom configurations, leading to increased installation time, labor costs, and the potential for errors. This complexity also makes it difficult for HVAC contractors to efficiently install and maintain these systems.

Existing solutions for integrating HVAC systems often lack flexibility and scalability, making it challenging to accommodate the unique requirements of different facilities. Many of these solutions require significant technical expertise to install and configure, further increasing the burden on HVAC contractors.

One example of a related system is described in U.S. Pat. No. 8,374,725 B1, titled “Multi-nodal thermostat control system” (Ols et al.). This patent discloses an electronically-controlled register vent (ECRV) that can be used to convert a non-zoned HVAC system into a zoned system or provide additional control and zones to a conventional zoned HVAC system. While this invention addresses some aspects of HVAC system control, it does not provide a comprehensive, plug-and-play solution for integrating multiple standalone HVAC systems in large facilities.

There is a need for a more efficient, cost-effective, and user-friendly solution for integrating and controlling HVAC systems in commercial and industrial facilities. Such a solution should simplify the installation process, reduce wiring costs, and enhance the overall reliability and performance of the HVAC system while providing flexibility and scalability to accommodate the unique needs of different facilities.

### SUMMARY

The present invention addresses the challenges associated with integrating and controlling multiple standalone HVAC systems in large commercial and industrial facilities by providing a modular, plug-and-play BMS (Building Management System) control box. This innovative solution streamlines the installation process, reduces wiring costs, and enhances the overall reliability and performance of HVAC systems.

The BMS control box is designed to simplify the integration of various HVAC components, significantly reducing installation time and costs. By offering plug-and-play capabilities, the control box minimizes the need for extensive wiring, providing a cost-efficient and flexible solution. The box is pre-wired with both a generic BACnet MSTP thermostat and a wireless device securely mounted inside, exposing only the specific plugs for technicians to connect. This ensures that each input and output can only be matched to its corresponding plug, preventing incorrect installations.

The invention solves the problem of high installation costs and complex integration processes associated with multiple standalone HVAC systems in large facilities. Traditionally, these facilities require extensive and expensive wiring to connect and control various HVAC components, leading to increased labor, time, and potential for errors. The BMS control box addresses these issues by providing a streamlined, plug-and-play solution that simplifies the integration process, reduces wiring costs, and enhances the overall reliability and performance of HVAC systems.

The BMS control box offers several advantages over existing systems, including cost efficiency, ease of installation, flexibility and scalability, enhanced reliability, and comprehensive support. The reduced wiring costs and lower labor costs contribute to overall cost savings. The plug-and-play design allows for quick and easy integration of HVAC components, minimizing downtime for facilities. The modular nature of the control box enables easy expansion to accommodate additional HVAC units as needed, providing flexibility for future growth or reconfiguration. The centralized control and robust design of the BMS control box ensure more stable and consistent HVAC operation, reducing the potential for wiring faults and connectivity issues.

Various aspects of the invention can be varied or altered while still accomplishing the end result. These include the dimensions and form factor of the control box, materials and construction, mounting mechanism, connectivity options, input and output interfaces, internal components, sensor wiring length, user interface, and power supply. This adaptability allows the BMS control box to be customized to suit the specific requirements of different facilities and environments.

In summary, the present invention provides a modular, plug-and-play BMS control box that simplifies the integration and control of multiple standalone HVAC systems in large commercial and industrial facilities. By reducing installation costs, enhancing reliability, and offering flexibility and scalability, this innovative solution addresses the limitations of existing systems and provides a more efficient and user-friendly approach to HVAC system management.

Additional features and advantages of the invention will be set forth in the description which follows, and in part will be obvious from the description, or may be learned by the practice of the invention. These and other features of the present invention will become more fully apparent from the following description, or may be learned by the practice of the invention as set forth hereinafter.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 is a system diagram illustrating the key components and connectivity of the building management system.

FIG. 2a is an exterior front view of a building management system (BMS) enclosure.

FIG. 2b shows an exterior rear view of the BMS enclosure.

FIG. 3 illustrates an interior view of the building management system (BMS) enclosure.

### DETAILED DESCRIPTION

In the following detailed description of the preferred embodiments, reference is made to the accompanying drawings, which form a part hereof and show, by way of illustration, specific embodiments in which the invention may be practiced. It is to be understood that other embodiments may be used and structural or logical changes may be made without departing from the scope of the present invention. The following detailed description, therefore, is not to be taken in a limiting sense, and the scope of the present invention is defined by the appended claims.

The following description is provided as an enabling teaching of the present systems, and/or methods in its best, currently known aspect. To this end, those skilled in the relevant art will recognize and appreciate that many changes can be made to the various aspects of the present systems described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The terms “a” and “an” and “the” and similar references used in the context of describing a particular embodiment of the present invention (especially in the context of certain claims) are construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein.

All systems described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word or as used herein means any one member of a particular list and also includes any combination of members of that list. Further, one should note that conditional language, such as, among others, “can,” “could,” “might”, or “may” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

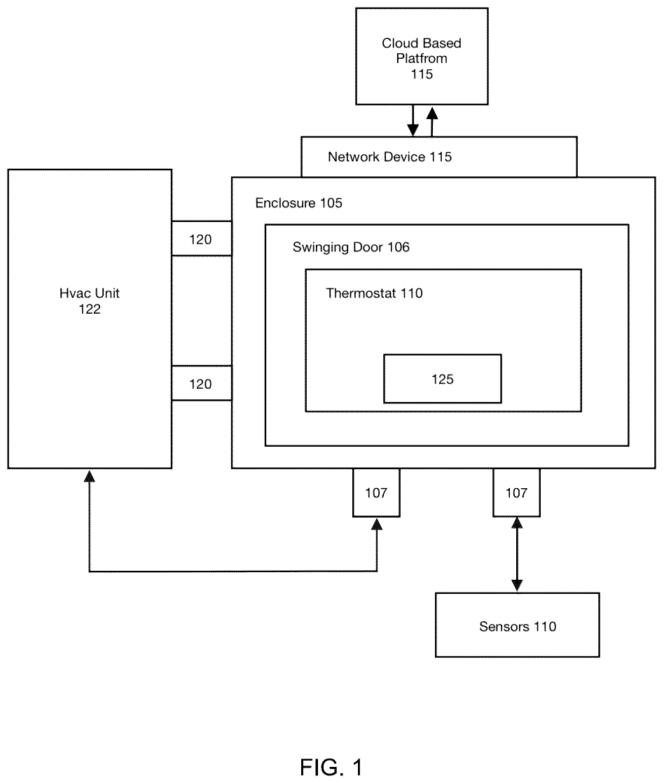

FIG. 1 is a system diagram illustrating the key components and connectivity of the building management system (BMS) 100 for integrating and controlling a plurality of HVAC units 120. The BMS 100 comprises a compact enclosure 105 designed to house and protect the internal components. The enclosure 105 is constructed from high-grade, corrosion-resistant steel and features a powder-coated finish for added durability. The enclosure 105 features a door 106 with a tamper-proof lock mechanism that allows authorized personnel easy access to the internal components for maintenance and troubleshooting purposes while preventing unauthorized access. The enclosure 105 is equipped with external mounting ports 107 that enable secure installation on various surfaces, such as concrete walls, wooden studs, or directly on the HVAC units 120.

Inside the enclosure 105, a state-of-the-art, programmable thermostat 110 is pre-wired and securely mounted using vibration-resistant fasteners. The thermostat 110, such as the Honeywell T6 Pro Smart Thermostat, is responsible for monitoring and controlling the temperature settings for the connected HVAC units 120. The thermostat 110 features a high-resolution, color touchscreen display and supports advanced scheduling, geofencing, and energy-saving features. A wireless mesh network device 115, such as the Zigbee-enabled Silicon Labs MGM13P Mighty Gecko Multiprotocol Wireless SoC, is also pre-wired and securely mounted within the enclosure 105 using a custom-designed, shock-absorbing bracket. The wireless mesh network device 115 is configured to communicate with the thermostat 110 using a high-speed, low-latency serial interface and transmit control signals to the plurality of HVAC units 120 using a robust, self-healing mesh network topology. The wireless mesh network device 115 supports various communication protocols, including BACnet, ZigBee, Z-Wave, and Bluetooth Low Energy (BLE), enabling seamless integration with different HVAC systems and building automation networks.

The BMS 100 includes a plurality of pre-wired, job-specific plugs 125 that are designed to connect to the corresponding inputs and outputs of the HVAC units 120. The plugs 125 are labeled using high-contrast, UV-resistant labels and color-coded using a standardized scheme for easy identification and error-free installation (not shown). The plugs 125 are constructed from high-quality, flame-retardant materials and feature gold-plated contacts for optimal signal integrity and corrosion resistance.

A plurality of pre-cut, shielded sensor wires 130 are provided with the BMS 100 for connecting various sensors, such as temperature, humidity, and occupancy sensors, to the system. These sensor wires 130 are cut to specific lengths, either 5 feet or 10 feet, depending on the job requirements and the location of the sensors relative to the BMS enclosure 105. The pre-cut lengths simplify the installation process and reduce the need for on-site wiring adjustments. The sensor wires 130 feature a multi-stranded, tinned copper conductor and a foil-shielded, plenum-rated jacket to minimize electromagnetic interference and ensure reliable data transmission.

The enclosure 105 can be optionally waterproofed to an IP67 rating using a proprietary, multi-layer sealing process to allow for external mounting directly on the HVAC units 122. This waterproofing feature provides flexibility in installation locations and ensures that the BMS 100 can withstand various environmental conditions, such as heavy rain, snow, and dust.

The wireless mesh network device 115 is capable of securely communicating with a cloud-based platform 140, such as Amazon Web Services (AWS) IoT Core, enabling remote monitoring and control of the connected HVAC units 122. The communication between the wireless mesh network device 115 and the cloud platform 140 is encrypted using industry-standard, end-to-end encryption protocols, such as Transport Layer Security (TLS) 1.2, to ensure data privacy and integrity. This cloud connectivity allows building managers and maintenance personnel to access real-time data, receive alerts, and make adjustments to the HVAC system from anywhere, using web-based interfaces built with responsive web design frameworks, such as Angular or React, or mobile applications developed using cross-platform tools like Flutter or React Native.

The BMS 100 is designed to be future-proof and adaptable to evolving HVAC technologies. The wireless mesh network device 115 can receive software updates over-the-air using a secure, encrypted update mechanism, enabling the addition of new features, enhancements to existing functionality, and compatibility with future HVAC systems and communication protocols. The software updates are managed through a robust, containerized continuous integration and continuous deployment (CI/CD) pipeline that ensures thorough testing and validation before deployment to the installed base of BMS 100 units.

Overall, the building management system (BMS) 100 provides a compact, pre-wired, and user-friendly solution for integrating and controlling multiple HVAC units 122 in a building. The combination of secure wireless communication using advanced SoC devices, pre-wired components with patented keying systems, and cloud connectivity powered by industry-leading IoT platforms offers a scalable and efficient approach to building automation and energy management. The use of high-quality, durable materials and advanced manufacturing techniques ensures that the BMS 100 can withstand the rigors of real-world installations and provide reliable, long-term performance.

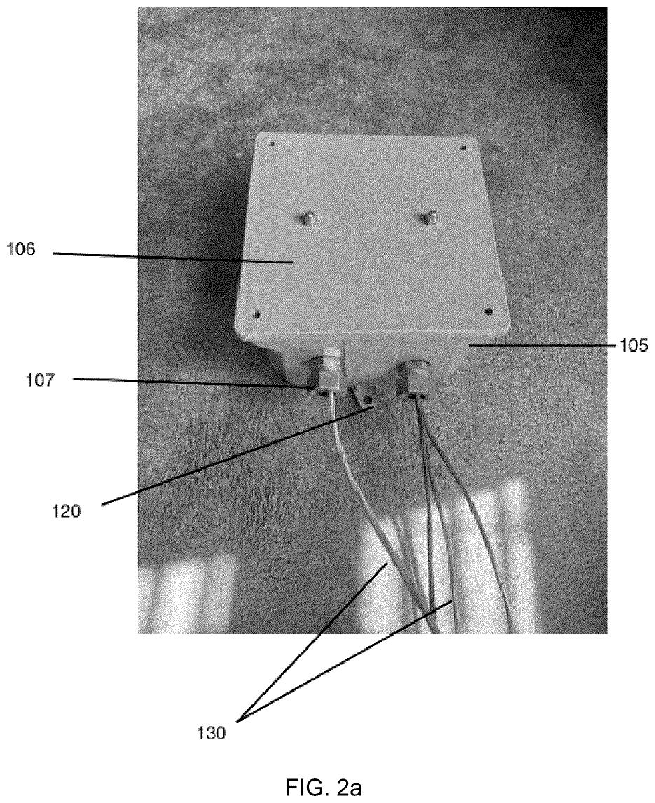

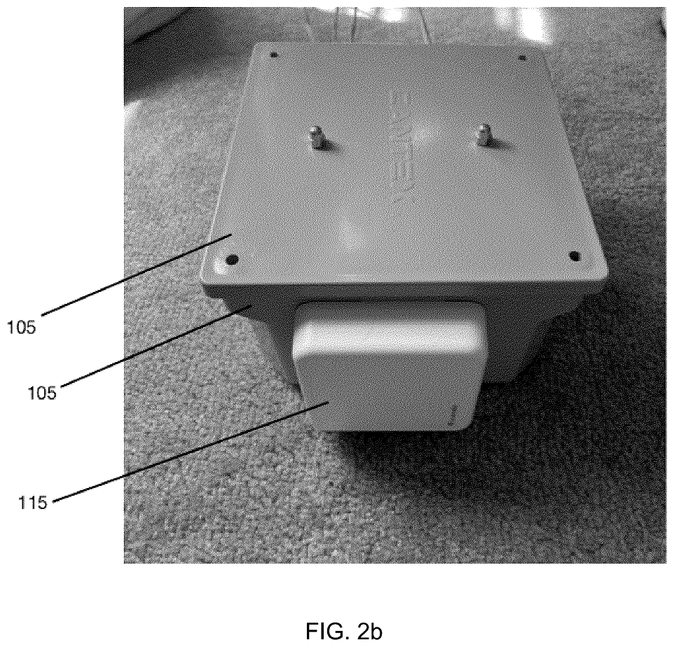

FIG. 2a is an exterior front view of a building management system (BMS) enclosure 105. The compact enclosure 105 measures approximately 7 inches by 7 inches by 5 inches and features a door 106 on the top for accessing the internal components. External outlet ports 107 are provided on the enclosure 105 for connecting pre-cut, shielded sensor wires 130.

FIG. 2b shows an exterior rear view of the BMS enclosure 105. The compact enclosure 105 includes external mounting clips 107 for secure installation on a surface. An external wireless antenna protrudes from the rear of the enclosure 105, enabling the wireless mesh network device 115 mounted inside the enclosure to communicate with a programmable thermostat 110 and transmit control signals to a plurality of HVAC units 120.

The BMS enclosure 105 is optionally waterproofed for external mounting directly on the HVAC units 120. Inside the enclosure 105, the programmable thermostat 110 and wireless mesh network device 115 are pre-wired and securely mounted. A plurality of pre-wired, job-specific plugs 125 are provided for connecting to corresponding inputs and outputs of the HVAC units 120. Each plug 125 is uniquely designed to fit only its intended input or output, preventing incorrect installations.

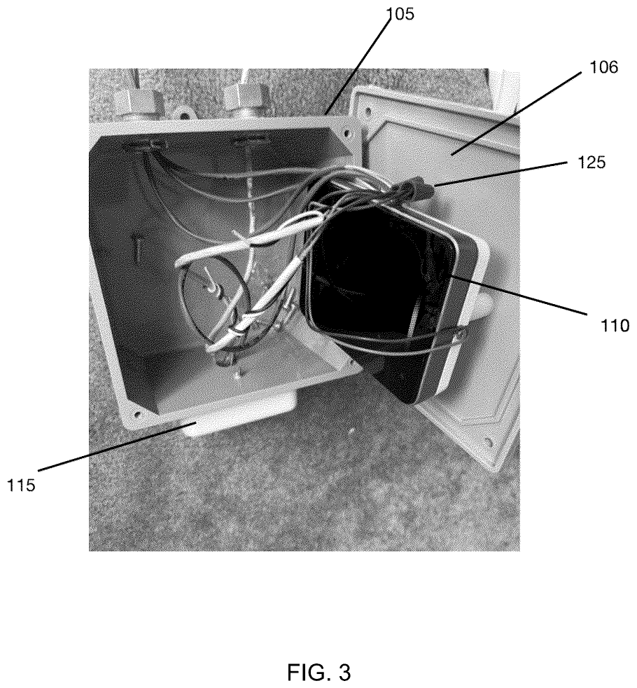

FIG. 3 illustrates an interior view of the building management system (BMS) enclosure 105. The compact enclosure 105 is designed with a door 106 that provides easy access to the internal components for installation and maintenance. The enclosure 105 also features external mounting clips 107 that enable secure installation on a wall or other suitable surface.

Inside the enclosure 105, a programmable thermostat 110 is pre-wired and securely mounted. The thermostat 110 is responsible for controlling the temperature settings and operation of the connected HVAC units 120. Adjacent to the thermostat 110, a wireless mesh network device 115 is also pre-wired and securely mounted within the enclosure 105. The wireless mesh network device 115 is configured to communicate wirelessly with the thermostat 110 and transmit control signals to the plurality of HVAC units 120, enabling seamless integration and centralized management.

The enclosure 105 includes a plurality of pre-wired, job-specific plugs 125 designed to connect directly to the corresponding inputs and outputs of the HVAC units 120. Each plug 125 is uniquely designed to fit only its intended input or output, effectively preventing incorrect installations and ensuring proper connectivity between the BMS 100 and the HVAC units 120. This plug-and-play approach simplifies the installation process and minimizes the risk of wiring errors.

In some embodiments (not shown in FIG. 2), the enclosure 105 may also house a backup power source, such as a battery pack or an uninterruptible power supply (UPS). The backup power source is designed to provide continuous operation of the BMS 100 during power outages, ensuring uninterrupted control and monitoring of the HVAC units 120.

The BMS enclosure 105 also includes provisions for connecting sensors using pre-cut, shielded sensor wires 130. These sensor wires 130 are designed to connect various sensors, such as temperature sensors, humidity sensors, or occupancy sensors, to the BMS 100. The pre-cut lengths and shielding of the sensor wires 130 simplify the installation process and ensure reliable transmission of sensor data to the BMS 100.

Overall, the interior view of the BMS enclosure 105 in FIG. 2 showcases the key components and features that enable the integration and control of multiple HVAC units 120. The compact design, pre-wired components, job-specific plugs 125, and optional backup power source 135 contribute to a user-friendly, efficient, and reliable building management solution.

The embodiments described herein are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. A building management system (BMS) for integrating and controlling a plurality of HVAC units, the system comprising:
a compact enclosure, the enclosure having a door for accessing internal components and external mounting clips for secure installation;
a thermostat pre-wired and securely mounted within the enclosure;
a wireless mesh network device pre-wired and securely mounted within the enclosure, the wireless mesh network device configured to communicate with the thermostat and transmit control signals to the plurality of HVAC units;
a plurality of pre-wired, job-specific plugs for connecting to corresponding inputs and outputs of the HVAC units, each plug designed to fit only its corresponding input or output to prevent incorrect installations; and
a plurality of pre-cut sensor wires, for connecting sensors to the BMS, wherein the enclosure is optionally waterproofed for external mounting on the HVAC units.

2. The building management system of claim 1, wherein the wireless mesh network device is configured to communicate using a BACnet protocol.

3. The building management system of claim 1, wherein the plurality of pre-wired, job-specific plugs are Turck plugs designed to prevent incorrect connections between the BMS and the HVAC units.

4. The building management system of claim 1, wherein the plurality of pre-cut sensor wires are cut to lengths of either 5 feet or 10 feet, depending on job-specific requirements.

5. The building management system of claim 1, wherein the compact enclosure measures approximately 7 inches by 7 inches by 5 inches.

6. The building management system of claim 1, further comprising a backup power source selected from the group consisting of a battery pack and an uninterruptible power supply (UPS), configured to provide continuous operation during power outages.

7. The building management system of claim 1, wherein the wireless mesh network device is capable of receiving software updates to enhance functionality and maintain compatibility with future HVAC technologies.

8. The building management system of claim 1, wherein the wireless mesh network device is configured to securely communicate with a cloud-based platform, enabling remote monitoring and control of the connected HVAC units.

9. The building management system of claim 1, wherein the wireless mesh network device is configured to communicate using a protocol selected from the group consisting of ZigBee, Z-Wave, and Bluetooth Low Energy (BLE).

10. The building management system of claim 1, wherein the enclosure further comprises a locking mechanism to prevent unauthorized access to the internal components.

11. A method for integrating and controlling a plurality of HVAC units in a building, the method comprising:
providing a pre-wired building management system (BMS) box, the BMS box comprising:
a compact enclosure with a door and external mounting clips,
a thermostat securely mounted within the enclosure,
a wireless mesh network device securely mounted within the enclosure, and
a plurality of pre-wired, job-specific plugs for connecting to corresponding inputs and outputs of the HVAC units;
mounting the BMS box securely on a surface using the external mounting clips;
connecting the plurality of pre-wired, job-specific plugs to their corresponding inputs and outputs on the HVAC units;
connecting a plurality of pre-cut sensor wires, to sensors and the BMS box;
configuring the wireless mesh network device to communicate with the thermostat and transmit control signals to the plurality of HVAC units; and
controlling the plurality of HVAC units using the thermostat and the wireless mesh network device.

12. The building management system of claim 1, wherein the wireless mesh network device is configured to communicate using a BACnet protocol.

13. The building management system of claim 1, wherein the plurality of pre-wired, job-specific plugs are Turck plugs designed to prevent incorrect connections between the BMS box and the HVAC units.

14. The building management system of claim 1, wherein the plurality of pre-cut sensor wires are cut to lengths of either 5 feet or 10 feet, depending on job-specific requirements.

15. The building management system of claim 1, wherein the compact enclosure measures approximately 7 inches by 7 inches by 5 inches.

16. The building management system of claim 1, wherein the BMS box further comprises a backup power source selected from the group consisting of a battery pack and an uninterruptible power supply (UPS), configured to provide continuous operation during power outages.

17. The building management system of claim 1, wherein the wireless mesh network device is capable of receiving software updates to enhance functionality and maintain compatibility with future HVAC technologies.

18. The building management system of claim 1, wherein the wireless mesh network device is configured to securely communicate with a cloud-based platform, enabling remote monitoring and control of the connected HVAC units.

19. The building management system of claim 1, wherein the wireless mesh network device is configured to communicate using a protocol selected from the group consisting of ZigBee, Z-Wave, and Bluetooth Low Energy (BLE).

20. The building management system of claim 1, wherein the enclosure further comprises a locking mechanism to prevent unauthorized access to the internal components of the BMS box.
